(19) United States
(12) Patent Application Publication
(10) Pub. No.: US 2018/0348388 A1
(43) Pub. Date: Dec. 6, 2018

(54) SENSOR SYSTEM

(71) Applicant: Fugro Technology B.V., Leidschendam (NL)

(72) Inventors: Michaël Dominique HOONAKKER, Buinen (NL); Paul W.P. HEDGES, Den Haag (NL)

(73) Assignee: Fugro Technology B.V., Leidschendam (NL)

(21) Appl. No.: 15/571,811

(22) PCT Filed: Apr. 28, 2016
(86) PCT No.: PCT/NL2016/050303

§ 371 Date: Nov. 3, 2017

(30) Foreign Application Priority Data
May 4, 2015 (NL) 2014762

(51) Int. Cl. G01V 1/20; G01V 1/38

(52) U.S. Cl. CPC G01V 1/202; G01V 1/3843; G01V 1/3808; G01V 1/3817

(57) ABSTRACT

System comprising at least one conductors and at least one sensing node which comprises at least one sensor device wherein each conductor is provided with at least one electrically conductive core surrounded by an insulating sheath wherein the at least one sensor device is electrically connected with at least one conductive core of at least one first conductor of the at least one conductor. The at least one node is provided with an attachment device for mechanically attaching the at least one node to at least one second conductor of the at least one conductor. The attachment device is arranged for mechanically attaching the at least one node to the at least one first conductor such that the insulating sheath at the location where the at least one node is attached to the at least one first conductor remains intact. The node is further provided with an inductive coupling device which is arranged to provide the electrical connection in the form of an inductive coupling of the at least one sensor device with at least one conductive core of the at least one second conductor.

The invention further relates to a sensing node of such a system.

Such a system and node are generally known. In the known system often two pairs of conductors are used. A first pair is used as a power line for submitting electric power from a power supply to the node. A second pair of conductors may be used for communication between a data processor and/or generating device and the node. Such known sensor system is for example used as a streamer attached to a ship and wherein the nodes are under water to carry out several geophysical, hydrographical or hydrological measurements. These measurements may be simultaneously applied and are applicable for different purposes.

A typical system which is used as a streamer may have several kilometers of sensing line, with nodes at approximately 1.5 m. spacing resulting in thousands of nodes that need to be individually attached to the conductors.

In the known systems the conductors need to be stripped of the insulating sheath at each point where an electrically conductive core needs to be electrically connected with the sensing node. This makes the system relatively expensive. Moreover, the electrical connection between the conductive core and the sensing node is usually established by means of (galvanic) soldering. Also this technique is relatively expensive. Moreover, in case the system is used as a streamer, as well as in other situations, the soldering points are often a failure point, a point penetration of conductive liquids (i.e. seawater) and therefore need to be protected. The invention intends to provide a solution for at least one of the above referred to problems.

In accordance with the invention the system is characterized by the characterizing portion of claim 1. The mechanical attachment should preferably be executed with minimal gap but without the need for a rigid contact such that the contact has minimal risk of mechanical failure (e.g. due to bending or stress).

Because in accordance with the invention the at least one sensor device is electrically connected with the at least one conductive core of the second connector by means of the inductive coupling, without the need for locally removing the insulating sheath, the electrical connection can be obtained easily without significant costs. Furthermore, because the insulating sheath remains intact, wherein soldering is avoided, the electrical connection is very reliable and no longer a failure point due to penetration of conductive liquids. It is noted that the at least one sensor device being electrically connected with the at least one conductive core of the second conductor by means of the inductive coupling also comprises embodiments wherein the sensor device comprises at least one sensor and a control unit via which the at least one sensor is electrically connected with the at least one conductive core of the second conductor by means of the inductive coupling device. The control unit may for example be used for converting data obtained by means of the sensor into a predetermined format for submitting the accordingly processed data to the inductive core. Thus, in a system according to the invention, a plurality of sensing nodes can easily and quickly be mechanically and electrically attached to the at least one conductor. Especially if hundreds of sensing nodes have to be attached to the at least one conductor which may have a length of several kilometers, the cost reduction is relatively high.

The mechanical attachment device may have several embodiments such as, for example, a clip or clamp for attaching the at least one sensing node to at least one of the conductors. The mechanical attachment device may include a magnetic attachment device. For each of the embodiments it holds that the invention may also relate to a system comprising at least two conductors and at least one sensing node which comprises at least one sensor device wherein each conductor is provided with a conductive core surrounded by an insulating sheath wherein the at least one sensor device is electrically connected with at least one of the conductive cores and wherein the at least one node is provided with an attachment device for mechanically attaching the at least one node to at least one of the conductors, characterized in that the attachment device is arranged for mechanically attaching the at least one node to at least one of the conductors such that the insulating sheath at the location where the at least one node is attached to the at least one conductor remains intact; and wherein the node is further provided with an inductive coupling device which is arranged to provide the electrical connection in the form of an inductive coupling of the at least one sensor device with the at least one conductive core if the node is mechanically attached to the at least one conductors by means of the attachment device and wherein the sheath of the at least one conductor from which the core is inductively coupled to the at least one sensor device by means of the coupling device remains intact where the inductive coupling device provides the inductive coupling with the core.

In accordance with a practical solution the at least one node is mechanically attached to at least two conductors.

According to a preferred embodiment the attachment device and the inductive coupling device are arranged so that if the node is attached to the at least one conductor by means of the attachment device, the node can be detached from the at least one conductor wherein the insulating sheath at the location where the node is attached to the at least one conductor remains intact if the node is detached from the at least one conductor. Because the at least one sensing node can be easily detached from the at least one conductor wherein the at least one conductor including its insulating sheath remains intact, it is very easy to replace a sensing node, for example, in case a sensing node malfunctions. It is also possible to disconnect a sensing node from the at least one conductor in order to reconnect the sensing node at another position to the at least one conductor. It is noted that in the known system, replacement of the hard connected sensing nodes is time consuming and economically relative expensive. In the known system this requires soldering and repairing the insulating sheath at a position where the soldering took place. In case a sensing node needs to be replaced after soldering, the soldering points need to be protected again for influences from its environment. The preferred embodiment of the invention also meets this problem.

In a practical embodiment it holds that the system is further provided with at least one power supply which is electrically connected with the at least two conductive cores for providing electric power to the at least one sensor device via the inductive coupling device.

Furthermore in a practical embodiment it holds that the system is further provided with at least one data processing and/or generating device which is electrically connected with the at least two cores by means of the inductive coupling device for submitting data to the at least one sensor device and/or for receiving data from the at least one sensor device.

Preferably it holds that the attachment device is arranged for mechanically attaching the at least one node to the at least two the conductors wherein the insulating sheath at the location where the at least one node is attached to each of the at least two conductors remains intact and wherein the attachment device is arranged so that if the node is mechanically attached to the at least two conductors by means of the attachment device, the node can be detached from the at least two conductors wherein the insulating sheath at the location where the node is attached to each of the at least two conductors remains intact if the node is detached from the at least two conductors.

Because in this embodiment the attachment device is arranged for mechanically attaching the at least one node to the at least two conductors, the attachment can be very reliable. In a practical embodiment it holds that the attachment device also forms the inductive coupling device. Such a system has the advantage that upon arranging the mechanical attachment of the sensor node to at least one of the conductors, the electrical connection is obtained at the same time. This further reduces time and costs for mounting the sensing node to at least one of the electrical conductors.

In a preferred embodiment it further holds that the inductive coupling device comprises a ferrite body and at least one first coil surrounding the ferrite body wherein the at least one first coil is electrically connected to the at least one sensor device and wherein the ferrite body is arranged to be surrounded by a second coil which is formed by a portion of the at least one core so that the at least one first coil and the at least one second coil are inductively coupled by means of the ferrite body. By using a ferrite body in conjunction with the first and second winding the inductive coupling can be very high. It is noted that a coil may be understood to comprise one winding of an electrical conductor or a plurality of windings of an electrical conductor.

In a preferred embodiment the shape of the ferrite body comprises three legs, a first body portion which extends between first ends of each of the legs and a second body portion which extends between the second ends of each of the legs wherein the first coil surrounds at least one of the legs and wherein the second coil surrounds at least one of the legs and wherein the ferrite body comprises two body parts which are arranged so that they can be at least partly separated from each other and reattached to each other for positioning the first coil so as to surround at least one of the legs and/or for releasing the first coil from the at least one leg. Especially such preferred embodiment has the advantage of a high inductive coupling. Preferably the node comprises a Printed Circuit Board, also indicated as a PCB, whereon the at least one sensor device is attached and wherein the at least one coil is formed by the PCB wherein the at least one coil extends parallel to a flat plane wherein the PCB extends. Such a node has as an advantage that it can be manufactured relatively cheaply. Preferably it holds that the at least one first coil comprises a plurality of windings. This further increases the inductive coupling (efficiency). In case that the node comprises a PCB as discussed, the plurality of windings are preferably stacked to each other in a direction perpendicular to the plane wherein the PCB extends.

In case the ferrite body comprises the three legs and a first and second body portion as discussed above, the coupling device is preferably provided with a removable clip for attaching the first body part and the second part to each other. Preferably the clip can be easily applied to the first and second body part. Also preferably the clip can be easily removed for at least partly detaching the first body part form the second body part so as to be able to remove the at least one first coil.

It is noted that the ferrite body may also have other advantage shapes. For example, the ferrite body may comprise a ring shaped body wherein the first coil and the second coil each surround a portion of the ring shaped body and wherein the ring shaped body comprises two body parts which are arranged to be at least partly separated from each other an reattached to each other for positioning the first coil so as to surround a portion of the ring-shaped body and/or for releasing the first coil from the ring-shaped body.

In accordance with an advantageous embodiment it holds that the at least one node is provided with a memory device wherein an identification code of the node is stored and wherein the node is arranged to submit information about the identification code in electric form to at least one of the conductive cores, possibly in association with information about measurement results obtained with the at least one sensor device and/or wherein the node is arranged to be controlled by a command submitted via at least one of the conductive cores to the node if the command comprises information about the identification code stored in the memory device. Because the at least one node is identifiable within the system, a plurality of nodes can be easily applied. In such a system each node is identifiable once attached to the at least one conductor. The identity of such nodes can be used for submitting information to a selected node which information comprises a selected identification code corresponding to the selected node or for receiving information from a node which information comprises a identification code of the node for identifying the node from which the information was received.

According to a highly advantageous embodiment the system is arranged for determining the position of the node relative to the conductors. More specifically it holds that the system is provided with a pinging or trigger unit which is arranged to submit a pinging signal to at least one of the conductive cores wherein the node is arranged to submit a reply to at least one of the conductive conductors upon receipt of the pinging signal and wherein the pinging unit is arranged to calculate the position of the node relative to the trigger, control unit or a predefined reference point based on the time difference between the moment on which the pinging signal is submitted to the at least one conductive core by the pinging unit and the moment on which the pinging unit has received the reply. Because, as explained, a plurality of sensing nodes can be easily attached to the at least two conductors on any desired position, it is very advantageous if the system itself can determine the exact position of a sensing node relative to the conductors.

In a practical embodiment it holds that the system comprises two pairs of conductors, wherein a first pair is coupled to the power supply and a second pair is coupled to the data processing and/or generating device wherein the node is provided with a first coupling device for coupling the sensor device with the first pair for providing power to the sensor device via the first pair and wherein the node is provided with a second coupling device for providing a data connection between the data processing and/or generating unit and the at least one sensor device via the second pair. Usually the first pair and the second pair will have no conductors in common. However, it is also possible that the first pair and the second pair have one conductor in common. In accordance with a preferred embodiment it holds that at least two conductors form a twisted pair. Such a twisted pair comprises a plurality of cross-over positions separated from each other in a longitudinal direction of the twisted pair where the two conductors of the twisted pair cross each other. In the above described embodiment with the three legs, the first coil may be formed by a first portion of the conductive core of a first conductor of the at least two conductors, and a second portion of the conductive core of a second conductor of the at least two conductors, wherein the first and second portions extend between two adjacent cross-over points of the twisted pair.

It is noted that the system can be used for several different purposes such as a streamer. However, it is also possible that the system is used on land. It is for example possible that the conductors and the sensing nodes of the system are attached to a building such as a bridge in order to monitor the position and movement of the structure. Also, it can be monitored under which weather influences the structure stands. In a more general way it holds that the at least one sensor device comprises at least one sensor from the group which comprises a seismic sensor, a water pressure sensor, a gas pressure sensor, a temperature sensor, a movement sensor, a 3 dimensional accelerometer, a velocity sensor, a gravity sensor, an antenna, an audio sensor and a camera. Preferably it holds that the node is hermetically sealed so that it is intrinsically safe and of potential use within hazardous environments. More specifically it is waterproof.

The invention also relates to a ship provided with a streamer for seismic research wherein the streamer is formed by a system in accordance with the present invention.

The invention will now be further explained on the basis of the attached drawings wherein:

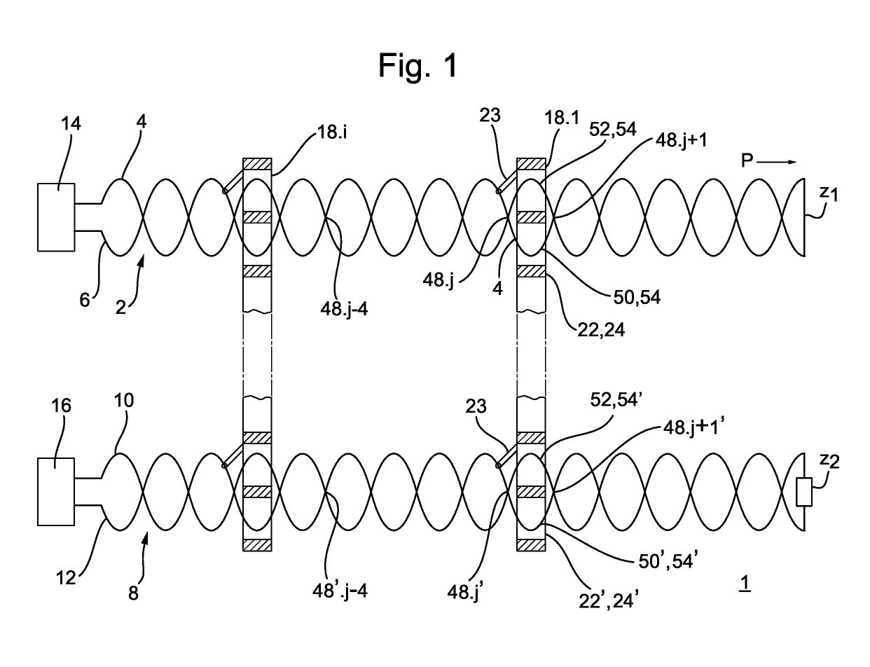

FIG. 1 shows a first embodiment of a system according to the invention;

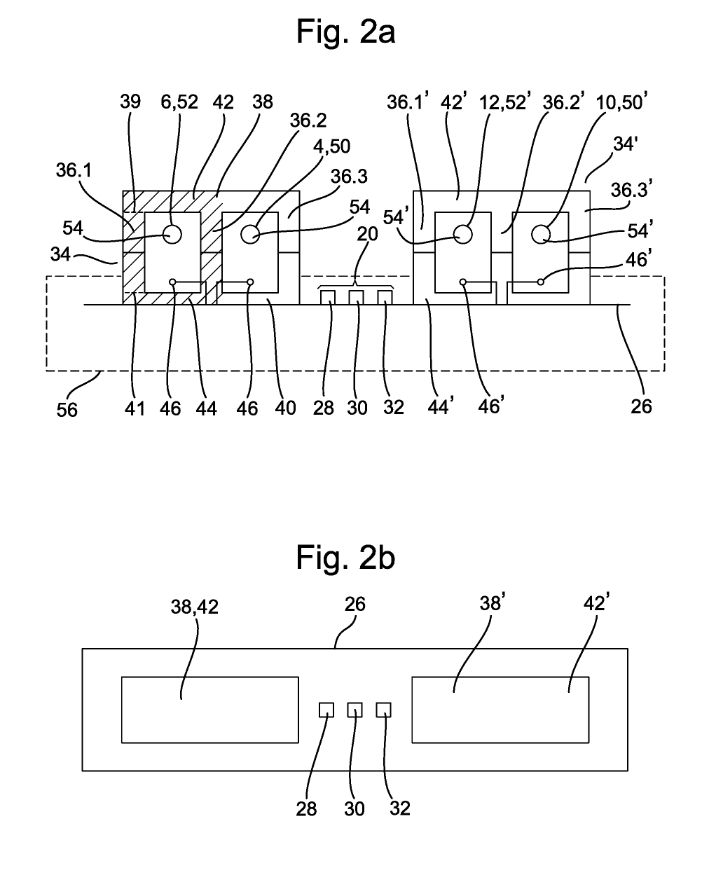

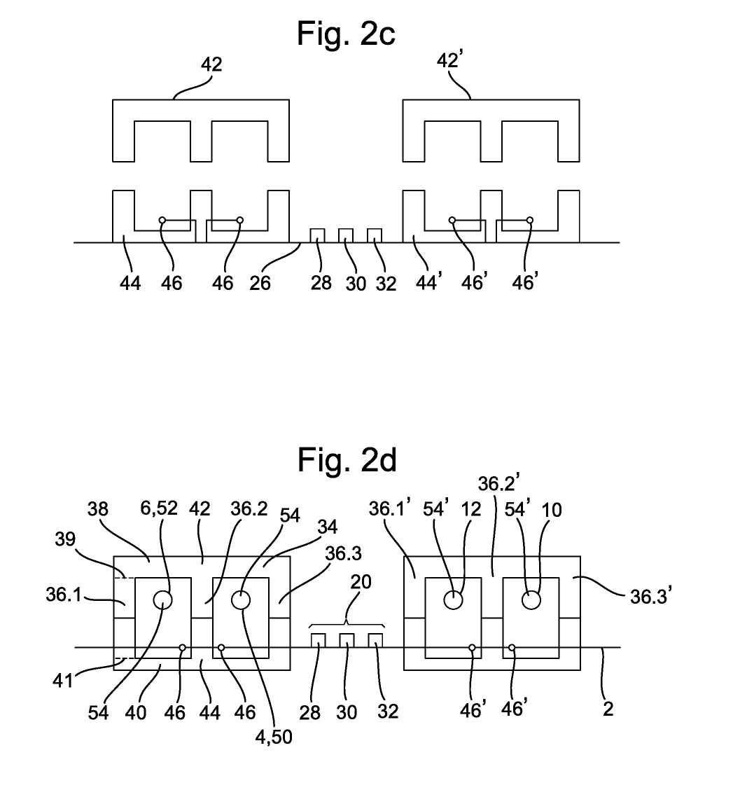

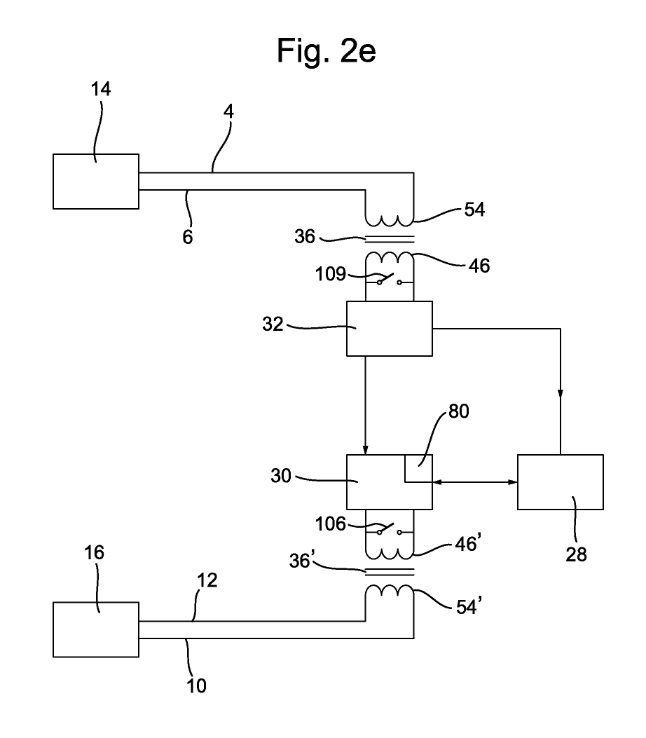

FIG. 2a shows a special embodiment of the system of FIG. 1;

FIG. 2b shown a top view of the node of FIG. 2a;

FIG. 2c shows the node of FIG. 2a in a condition wherein the first and second body parts are separated from each other;

FIG. 2d shows an alternative embodiment of a node of the system of FIG. 1;

FIG. 2e shows a schematic electrical diagram of the system of FIG. 1.

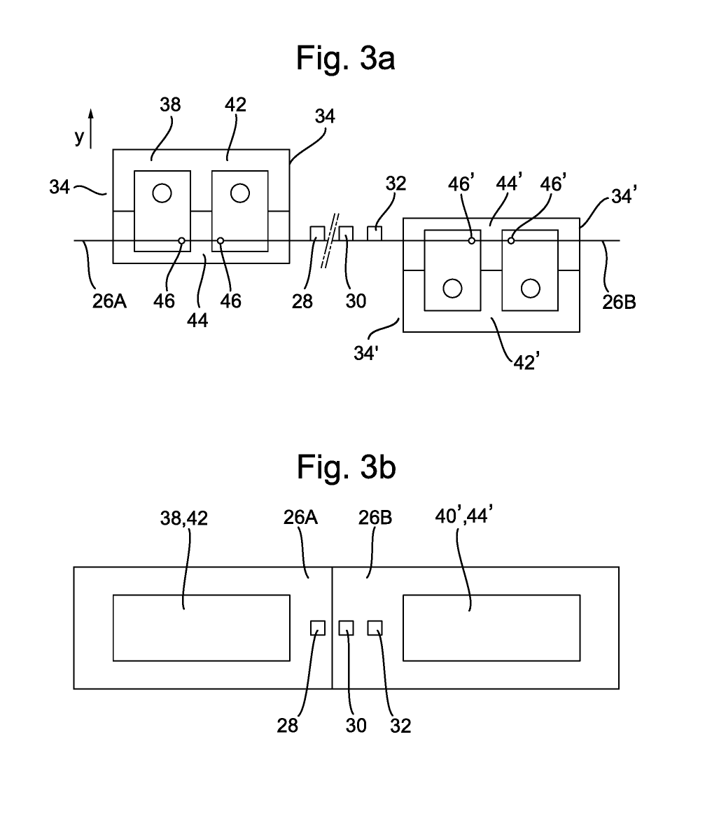

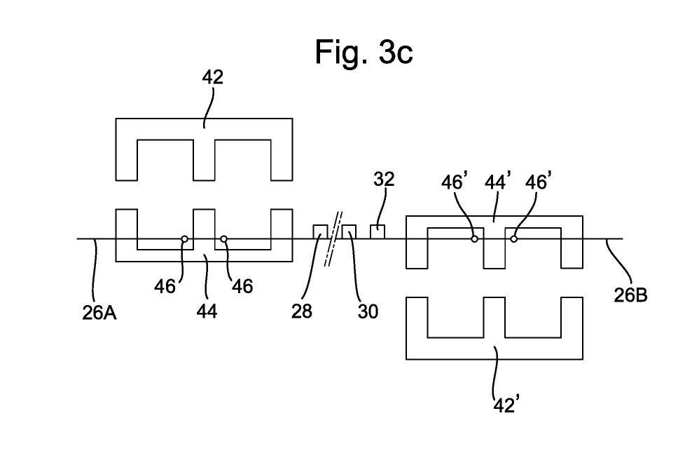

FIG. 3a shows an alternative embodiment of a node of the system of FIG. 1;

FIG. 3b shows a top view of the node of FIG. 3a;

FIG. 3c shows the node of FIG. 3a in a condition wherein a first and second body parts are separated from each other;

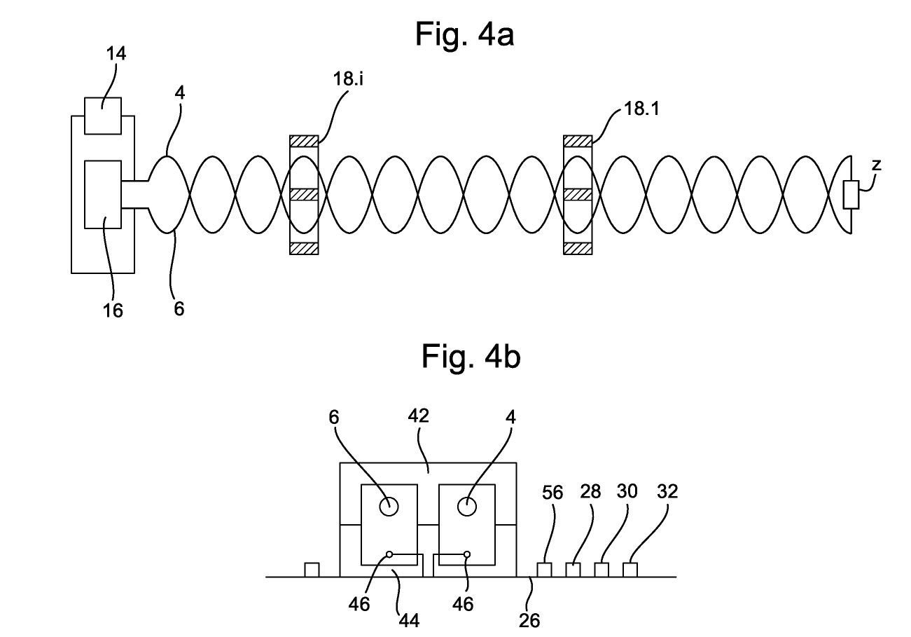

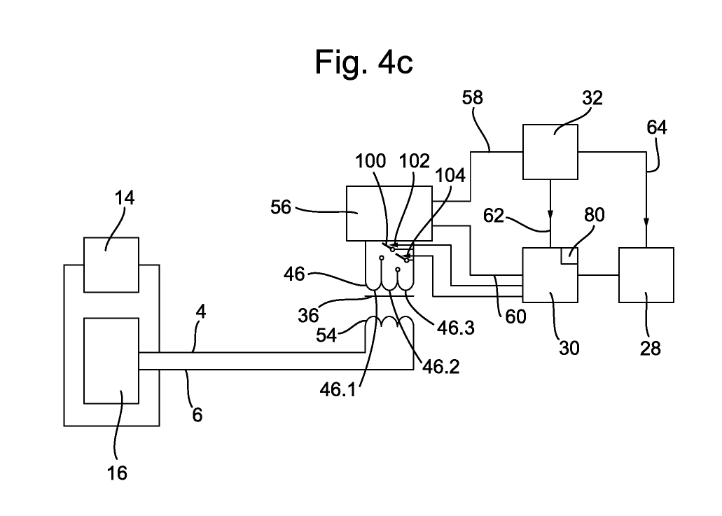

FIG. 4a shows an alternative embodiment of a system according to the invention;

FIG. 4b show a possible embodiment of a node of the system from FIG. 4a;

FIG. 4c shows a schematic electrical diagram of the system of FIG. 4a;.

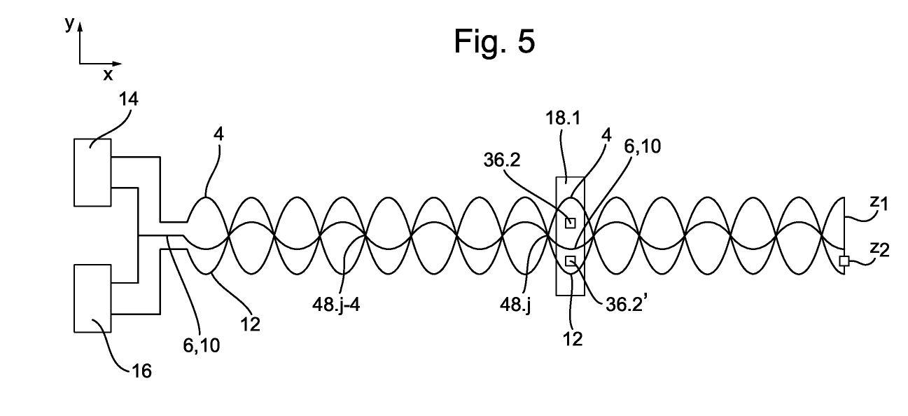

FIG. 5 shows another embodiment a system according to the invention;

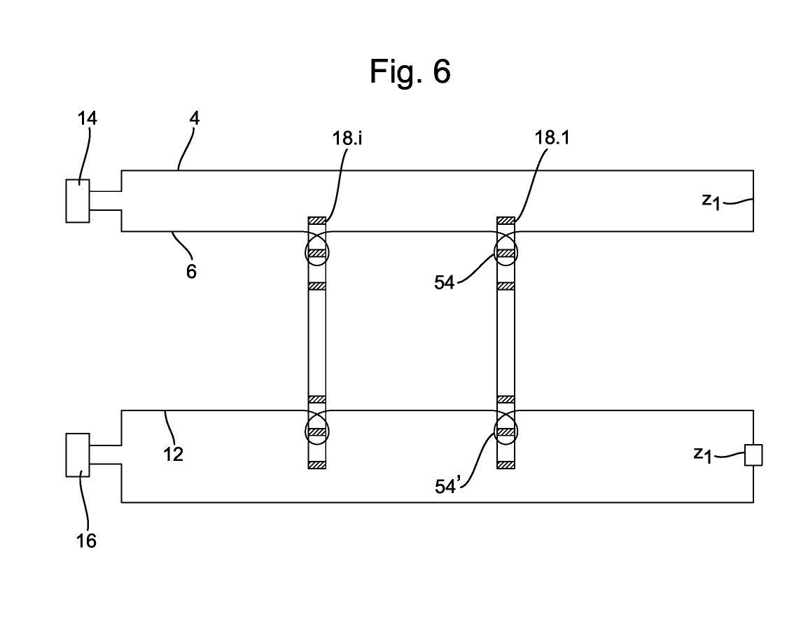

FIG. 6 shows another embodiment of a system according to the invention;

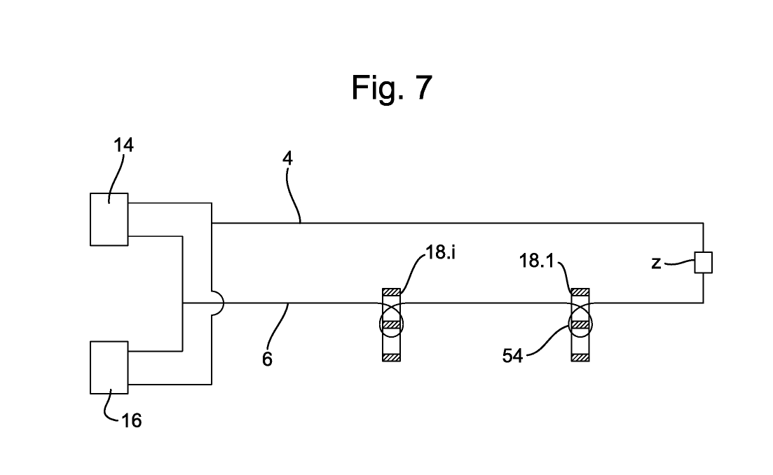

FIG. 7 shows another embodiment of a system according to the invention;

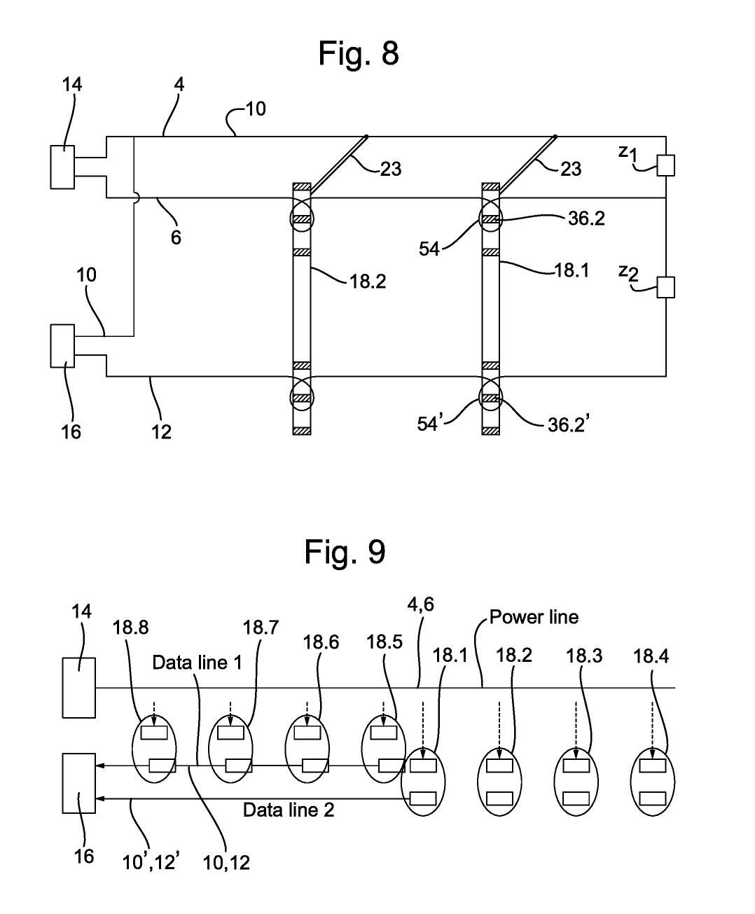

FIG. 8 shows another embodiment of a system according to the invention;

FIG. 9 shows another embodiment of a system according to the invention;

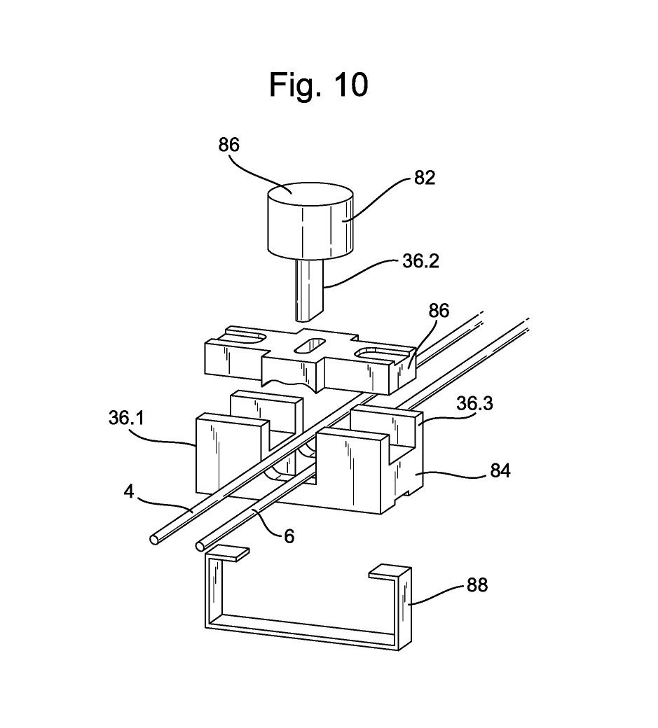

FIG. 10 shows a possible embodiment of a ferrite body of the node according to FIGS. 2a, 2d, 3a and 4b and;

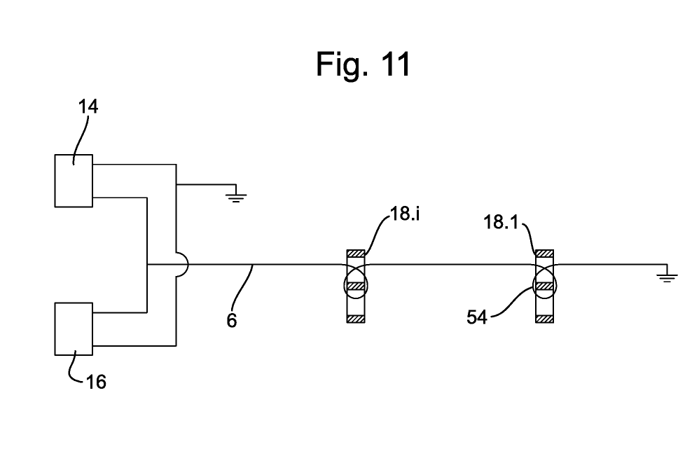

FIGS. 11-14 show other embodiments of a system according to the invention;

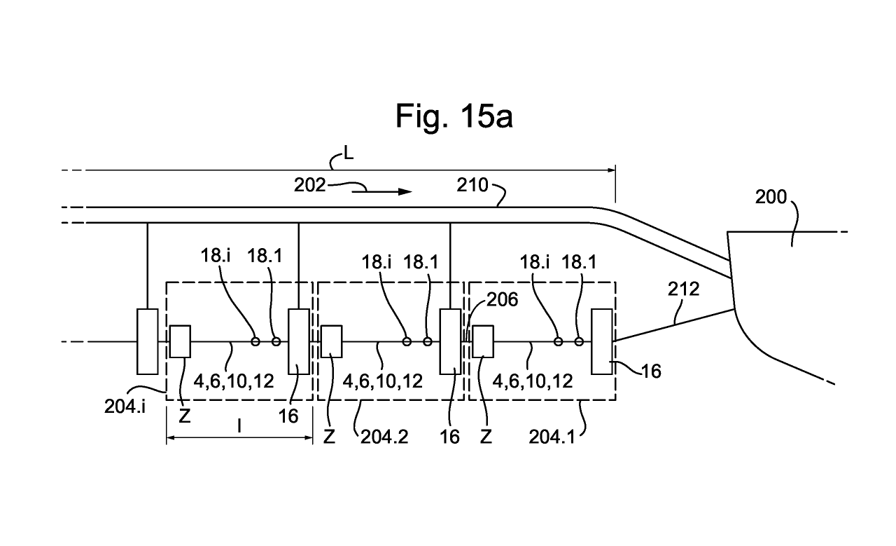

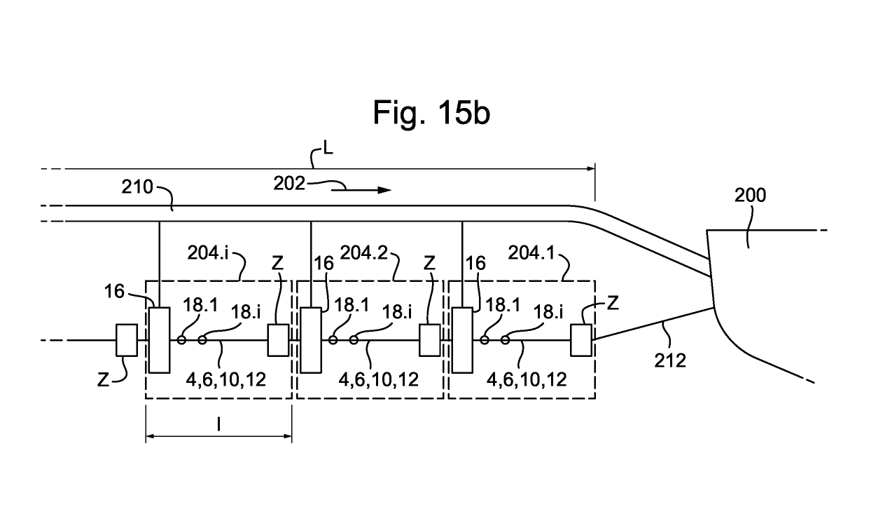

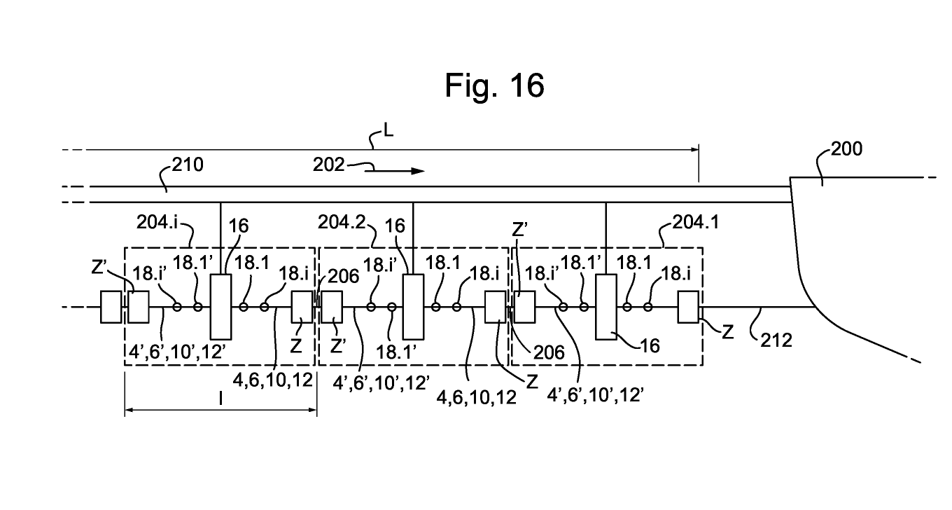

FIGS. 15a, 15b, 16 provided an embodiment of a system in the form of streamer according to the invention provided with systems according to any one of FIGS. 1-14.

In FIG. 1 reference number 1 denotes a sensor system in accordance with the present invention. The sensor system comprises a first pair 2 of conductors 4, 6 and a second pair 8 of conductors 10, 12. The first pair 2 of conductors is connected to a power supply 14. The second pair 8 of conductors is coupled to a data processing and/or data generating device 16. The system further comprises a plurality of sensing nodes 18.i(i=1,2,3, . . . n). In this embodiment only the sensing node 18.1 and 18.i are schematically shown for clarity reasons.

In this embodiment the sensing node 18.1 has the same structure as the sensing node 18.i wherein only the structure of sensing node 18.1 will be discussed.

Each of the conductors 4, 6, 10, 12 is provided with an electrically conductive core surrounded by an insulating sheath. The conductive core can comprise for example copper, whereas the insulating sheath may have the form of an insulating coating and/or a well-known plastic layer.

The sensing device 18.1 is electrically connected with the conductors 4, 6 (referred to as second conductors in the claims) on the one hand and is also electrically connected with the conductors 10, 12 (referred to as second conductors in the claims) on the other hand. Furthermore, it holds in this example that the sensing node 18.1 is mechanically attached to each of the conductors (referred to as first conductors in the claims). The sensing node comprises at least one sensor device 20 for sensing its environment. The sensor device 20 (see FIG. 2 or FIG. 3) may comprise at least of a plurality of sensors such as a seismic sensor, a water pressure sensor, a gas pressure sensor, a temperature sensor, a movement sensor, three-dimensional accelerometer, a velocity sensor, a gravity sensor, an antenna, an audio sensor, a camera etc.

In this example the sensor node 18.1 is provided with a first attachment 22 device which is arranged for mechanically attaching the sensor node 18.1 to conductors 4, 6 such that the insulating sheath at the locations where the at least one node is mechanically attached to the conductors 4, 6 remains intact. The node is further provided with a first inductive coupling device 24 which is arranged to provide an electrical connection between the sensor device 20 and the conductive cores of the conductors 4, 6. The electrical connection takes the form of an inductive coupling of the sensor device with the conductive cores of the conductors 4, 6 if the node is mechanically attached to the at least one conductor by means of the attachment device 22. Furthermore, the conductors 4, 6 from which the cores are inductively coupled to the sensor device 20 by means of the coupling device 24 remain intact where the inductive coupling device provides the inductive coupling with these cores. In this example, the first attachment device 22 comprises the first inductive coupling device 24. A possible embodiment of how this can be arranged is shown in FIG. 2a-2c. FIG. 2a shows a possible embodiment of the sensing node 18.1 wherein the sensing node 18.1 is provided with a PCB 26. The sensor device 20 is attached to the PCB and comprises in this example a sensor 28, a control unit 30 for controlling the node as well as a rectifier 32 for powering the control unit 30 and the sensor 28 (see also FIG. 2e). The control unit may be arranged for controlling the sensor and/or for processing data obtained by means of the sensor. This processing may include conversion of data obtained by means of the sensor into a predetermined format. The processing may also include a certain predetermined data reduction wherein the reduced amount of data is submitted to at least one of the conductors as will be discussed by way of an example hereafter. The controlling of the sensor may comprise for example tuning the sensitivity of the sensor.

The sensing node 18.1 further comprises a first ferrite body 34 which in this example forms the first attachment device 22 as well as the first inductive coupling 24 as shown in FIG. 1. The shape of the ferrite body 34 comprises three legs 36.1-36.3, a first body portion 38 which extends between first ends 39 (only end 39 of leg 36.1 is indicated in the drawing) of each leg and a second body portion 40 which extends between second ends 41 of each of the legs (only the second end 41 of the first leg 36.1 is indicated in the drawings). Thus in the example, the shape of the ferrite body is eight-shaped. The ferrite body 34 comprises a first body part 42 and a second body part 44 which are arranged so that they can be at least partly separated from each other (see FIG. 2c) and can be re-attached to each other (see FIG. 2a). The coupling device further comprises a first coil 46 which surrounds in this example the second leg 36.2. In this example the first coil 46 is provided with a plurality of windings. The first coil is connected via the PCB 26 to the sensor device 20, in this example with the rectifier 32 of the sensor device 20 (see also FIG. 2e).

It holds further in this example that the conductors 4, 6 form a twisted pair. The twisted pair 4, 6 comprises a plurality of cross-over positions 48.j as shown in FIG. 1. These cross-over positions are separated from each other in a longitudinal direction P of the twisted pair of conductors 4, 6. In this example, a second coil is formed by a first portion 50 of the conductor 4 which extends between two adjacent cross-over points 48.j and 48.j+1 and a second portion 52 of the conductor 6 which extends between the same two adjacent cross-over points. In other words the portions 50 and 52 each extend between two adjacent cross-over points 48.j and 48.j+1 wherein these two portions of the conductors 4, 6 form a second coil which comprises a single winding. The adjacent cross-over points where between the first part of the conductor 4 and the second part of the conductor 6 extends are indicated with reference numbers 48.j and 48.j+1 respectively.

Thus, as can be understood from FIG. 2c the first body part 42 can be removed from the second body part 44 so that the second coil which is formed by the portions 50, 52 of the twisted conductors 4, 6, can be positioned to surround, in this example, the second leg. After that, the first body portion can be positioned on top of the second body portion, for example by means of a clip, so that an inductive coupling is obtained between the sensor device 20 on the one hand and the conductors 4, 6 on the other hand. More specifically, an inductive coupling is obtained between the rectifier 32 of the sensing device 20 and the conductors 4, 6. The power supply generates an AC current with a frequency of, for example, 330 kHz. The AC current may have the shape of a square or a sinus wave or another shape. Other frequencies are also possible.

In this example the sensing node 18.1 further comprises a second attachment device 22′ and a second inductive coupling device 24′ as shown in FIG. 1. The second attachment device 22′ and the second inductive coupling device 24′ basically have the same shape and configuration as discussed for the first attachment device 22 and the first inductive coupling device 24. As shown in FIG. 2a, the inductive coupling device 22′ is also provided with three legs 36.1′-36.3′, a first body portion 38′ and a second body portion 40′. The ferrite body 34′ also comprises first and second body parts 42′, 44′ which can be separated from each other as shown in FIG. 2c. The second coupling device 24′ also comprises a first coil 46′ which surrounds the second leg 36.2′ on the one hand and which is connected to the sensor device, in this example with the control unit 30 of the sensor device 20 (see FIG. 2e) so that, in use, a data communication can take place between the control unit 30 and the data processing and data generating device 16 via the conductors 10, 12. Also in this example the conductors 10, 12 are twisted conductors. Also in this example the conductors 10, 12 are provided with a plurality of cross-over points 48.j′. Furthermore, a first part 50′ of conductor 10 and a second part 52′of conductor 12, which extend between two adjacent cross-over points 48′.j and 48′.j+1 form a second coil 54′ which comprises one winding. In this example the data processing and generating device 16 and the control unit 30 communicate with each other over the conductors 10, 12 using an electrical signal with a frequency of 2 MHz. The communication code may be in Manchester code format. However, other frequencies and other coding schemes are also possible. The control unit 30 communicates with the sensor 28 (see FIG. 2e) and may for example transfer data obtained by means of the sensor into the Manchester code format.

The system which has been described up until this point works as follows.

The conductors 4, 6, the conductors 10, 12 and the power supply 14 together with the date processing and generating unit 16 are made available for sensing nodes 18.i to be attached to these conductors. If the sensing node 18.1 is to be attached to the conductors 4, 6 and 10, 12 the first body part 42 will be separated from the second body part 44 (FIG. 2c). In that situation, it is remembered that the first coil 46 is already in place as a fixed part of the sensing node 18.1. The same applies for the first coil 46′. If the first body part 42 is detached from the second body part 44 as shown in FIG. 2c, a second coil 54 can be selected from the conductors 4, 6 to surround the second leg 36.2. After that, the first body part 42 is re-attached to the second body part 44, for example by means of a clip (not shown). As a result, the sensing node 18.i is mechanically attached to the conductors 4, 6 by means of the first attachment device 22. At the same time the sensing device 20, more particularly the rectifier 32 of the sensing device, is inductively coupled to the conductors 4, 6 by means of the first inductive coupling device 24. The first attachment device 22 and the first inductive coupling device 24 are both formed by the ferrite body 34 in this example. Furthermore, the first body part 42′ is separated from the second body part 44′ as shown in FIG. 2c. This provides the possibility to position the second coil 54′ around the second leg 36.2′. Subsequently, the first body part 42′ is attached to the second body part 44′ by joining means, in this example a clip (which clip is not shown). It will be appreciated that the joining means may be, for example a clip, magnetic means, or any other kind of detachable joining means. Again, as a result, the sensing node 18.1 is mechanically attached to the conductors 10, 12 by means of a second attachment device 22′ wherein the sensing device, more particularly, the control unit 30 of the sensing device is inductively coupled to the conductors 10, 12 by means of the second inductive coupling device 24′ (see also FIG. 2e). Again it holds that the second attachment device 22 and the second inductive coupling device 24′ are formed by one and the same means, in this example the ferrite body 34′. The sensing node 18.1 is now operational wherein at the locations where the sensing node 18.1 is mechanically attached to the conductors 4, 6, 10, 12, the sheath of the conductors remains intact. Also, the locations where the sensing node 18.1 is inductively coupled with the conductors 4, 6, 10, 12, the insulating sheath of the conductors remains intact. In a similar way as described for sensing node 18.1, other nodes 18.i can be mechanically and electrically connected with the conductors 4,6 and 10, 12 respectively.

After that, for example sensing node 18.1 is attached to the conductors 4, 6 and 10, 12 respectively wherein due to this attachment the insulating sheath of each of the conductors remain intact, it is also possible to disconnect the sensing node 18.1 from the conductors 4,6 and 10,12 respectively. As is shown in FIG. 2c the first body part 42 can be released from the second body part 44, for example by removing a clip (not shown) which holds the first body part 42 and the second body part 44 together. In the condition as shown in FIG. 2c the second coil 54 which is formed by the conductors 4, 6 can be removed from the second leg 36.2. Similarly the first body part 42′ can be released from the second body part 44′, for example by removing a clip which normally holds these body parts together (clip not shown). In this condition as shown in FIG. 2c the second coil 54′ which is formed by the conductors 10,12 can be removed from the second leg 36.2′. Basically this means that the sensing node 18.1 is completely de-attached from the conductors 4,6 and 10,12 respectively so that this node can be replaced by another node if the sensing node 18.1 would malfunction or so that the sensing node 18.1 can be re-attached to the conductor at another position to the conductors 4,6 and 10, 12 if desired. In the same way it is also possible to reconfigure the system by adding other types of nodes and/or removing or replacing the existing nodes to make the system suitable for other functions. It is noted that the sensing node 18.1 as shown in FIG. 2a may further be provided with a housing 56 wherein, for example, the PCB 26, the sensor 28, the control unit 30, the rectification unit 32 and a portion of the second body part 44 are positioned. The same holds for the second body part 44′. The housing 56 is shown schematically in FIG. 2a only.

It is clear that in the embodiment of FIG. 2a the ferrite body 34 provides an inductive coupling between the first coil 46 and the second coil 54. This type of coupling is known as such. In fact, the first coil, the second coil and the ferrite body form a transformer. In the embodiment discussed, the first coil 46 may be provided with a plurality of windings. It is however also possible that the first coil extends around the first leg 36.1 or the third leg 36.3. Also, the second coil 54 may surround around the first leg 36.1 or the third leg 36.3. Moreover, it is not required that the first coil 46 and the second coil 54 each extend around one and the same leg.

It is also possible that, for example, the first coil 46 comprises several windings which extend around the first leg, the second leg and/or the third leg respectively. If, for example, the first coil has windings around the first leg and the second leg, then the windings of the first leg are wound in a direction which is opposite to the windings which extend around the second leg. If the first coil comprises windings which extend around both the first leg and the third leg, then these windings should be wound in the same direction. Similarly, if the first coil comprises windings which extend around the second leg and the third leg, then the direction of these windings should be opposite. Thus each and a plurality of legs can be selected to be surrounded by the first and/or second coil.

In FIG. 2a the first ferrite body 34 and the second ferrite body 34′ are both positioned on top of one and the same PCB. It is however also possible as shown in FIG. 2d that the windings of the second coil 34 are formed on and/or in the PCB 26. In that case a portion of the second body part 44 is located on one side of the PCB whereas another portion of the second body part is located on an opposite side of the PCB. The same applies for the second body part 44′. The first body part 42 as well as the first body part 42′ can be disconnected from the second body part 44 and the second body part 44′ in a similar way as shown in FIG. 2c for positioning or removing the second coils 54 and 54′ respectively.

As shown in FIGS. 3a and 3b, it is also possible that the first ferrite body 34 is attached to a first PCB 26Aa whereas the second ferrite body 34′ is attached to a second PCB 26B. In this example the PCB 26A and the PCB 26B form one and the same PCB. Furthermore in this example, the first body part 42 is located on a side of the PCB 26A which is opposite on the side of the PCB 26B where the first body part 42′ is positioned. As discussed for FIG. 2d the first coil 46, as well as the second coil 46′ each extend in or on the PCB 26A, 26B. It is possible that the first coil 46 of the embodiment as shown in FIG. 3a comprises a plurality of windings which are stacked to each other in a direction which is perpendicular to the PCB 26A. Similarly the first coil 46′ may be provided with a plurality of windings which are stacked relatively to each other in a direction perpendicular to the PCB 26B. In the example as shown in FIG. 3a the PCB 26A and 26A form one and the same PCB. It is however also possible that, for example, PCB 26A is offset in a direction y relative to the PCB 26B. Such varieties all fall within the scope of the invention.

The system according to FIG. 4 shows a variety of the system according to FIG. 1 wherein similar devices are provided with the same reference number.

In the system according to FIG. 4a-4c both the power supply 14 as well as the data processing and generating device 16 are connected with the twisted pair of conductors 4,6. The power signal generated by the power supply 14 and data signals generated by the data processing and generating means as well as by the control unit 30 of the sensing node 18.1 are superimposed to each other on conductors 4,6. Because both signals have different carrier frequencies, those signals can be separated in the sensing node wherein the relatively low frequency power signal is submitted to the rectifier 32 and the relatively high frequency data signal is submitted to the control unit 30 if such signal is generated by the data processing and generating unit 16. If such a relatively high frequency data signal is generated by the control unit 30 and supplied to the twisted conductors 4,6 such signal is received by the data processing and generating device 16 wherein this device is designed to filter out the power supply signal.

The sensing node 18.i as shown in FIG. 4a in this example corresponds to the sensing node as shown in FIG. 2a wherein however the second ferrite body 34′ is omitted. As shown in FIG. 4c the free ends of the coils 46 are connected to a circuit 56 which separates a signal received from conductors 4,6 in a signal which originates from the power supply 14 which signal is submitted to rectifier 32 via a lead 58. The circuit 56 submits a signal which originates from the data processing and generating device 16 to the control unit 30 via a lead 60. The circuit 56 can be provided with appropriate filters for distinguishing between the power signal originating from the power supply 14 and the data signal originating from the data processing and generating unit 16, for example, based on the carrier frequency of these respective signals. The power supply provides the control unit 30 and the sensor 28 with power via leads 62 and 64.

If the second ferrite body 34′ is omitted, the sensor node 18 may be embodied as shown in FIG. 4b.

In the embodiment of FIG. 5 and FIG. 1 parts corresponding with each other are provided with the same reference number. A difference between these embodiments is that in FIG. 5 the conductors 6,10 are one and the same conductor. Conductors 4 and 12 extend in a plane defined by vectors x and y. The conductor 6 extends in a plane defined by the vector x and z where z is perpendicular to the vectors x and y. Thus it holds that conductors 4 and 6 form a twisted pair whereas also conductors 10 and 12 form a twisted pair wherein the conductors 6 and 10 are one and the same conductor. The power supply unit 14 submits its power signal to the conductors 4 and 6. The data processing and generating unit 16 submits a data signal as well as receives data signals via conductors 10, 12. Each of the conductors cross each other at cross-over points 48.j. The sensing node 18.1 which is shown in FIG. 5 is basically the same sensing node as shown in for example FIG. 2a, 2d or 3a. For clarity reasons it is only shown in FIG. 5 that the second leg 36.2 is surrounded by a second coil 34 which is formed by the conductors 4, 6. Furthermore it is only shown that, the second leg 36.2′ is surrounded by the second coil 54′ which is formed by the conductors 12 and 10.

In the embodiment of FIG. 1 and FIG. 6 features which correspond with each other, have been provided with the same reference numbers. In the embodiment of FIG. 6 the conductors 4 and 6 do not form a twisted pair of conductors. The same applies to conductors 10 and 12. For obtaining the second coil 54, the conductor 6 is twisted at the location where it is intended to attach the sensing node 18.1 to the conductor 6. Once the second coil 54 is formed, the coil can be positioned to surround the second leg 36.2 as discussed for the embodiment for FIG. 1. In a similar way, the conductor 12 can be twisted such that the second coil 54′ is formed. Also the second coil 54′ can then be located to surround the second leg 36.2 as discussed for FIG. 1. If an AC current signal is supplied to the conductors 4 and 6 the changing current in the conductor 6 will generate a change in magnetic field by means of the second coil 54 in the second leg which magnetic field will generate a corresponding signal in the first coil 46 of the sensing node and which is submitted to the rectifier 32. Similarly if a carrier signal which is modulated by data is submitted to the conductors 10, 12 by means of the data processing and generating unit 16 the changing current in the conductor 12 will generate a change in magnetic field in the second leg 36.2 which will generate a change in electrical signal in the first coil 46′ which is submitted to the control unit 30. If the control unit 30 supplies a modulated carrier signal to the first coil 46′, this first coil will generate a change in magnetic field in the second leg 36.2′ which will generate a changing electric current in the second coil 54′ which can be detected by the data processing and generating unit 16. Thus the system of FIG. 6 operates in a similar way as explained for FIG. 1.

In the embodiment of FIG. 7 and the embodiment of FIG. 4a and the embodiment of FIG. 1, corresponding parts are provided with the same reference numbers.

Similarly as explained for FIG. 4a, the power supply signal generated by the power supply 14 is supplied to the conductors 4, 6. Also a data signal generated by the data processing and generating unit 16 is supplied to the same conductors 4 and 6. A difference with the embodiment 4a is that the conductors 4 and 6 do not form a twisted pair.

As discussed for FIG. 6 the conductor 6 is twisted so that it forms a second coil 54. This second coil 54 is located around the second leg 36.2 of the embodiment of the sensing node 18.1 as discussed for FIGS. 4a - 4c. Similarly, any sensing node 18.i can be attached to the conductor 6 on any desired position. It is noted that in the embodiment of FIG. 6 the ferrite body 34 forms an attachment device 22 which attaches the sensing node to only one conductor 6. Furthermore the ferrite body 34 forms an inductive coupling device which electrically couples the sensing device of the sensing node 18.1 to only one conductor 6.

In FIG. 8 again an alternative embodiment is shown wherein conductors are used which do not form twisted pairs. Furthermore, conductors 4 and 10 form one and the same conductor. By twisting conductor 6 a second coil 54 is formed which is positioned around the second leg 36.2 in similar manners as discussed for the other embodiments. Also by twisting the conductor 12, a second coil 54′ is formed which can be positioned to surround the second leg 36.2′. The power supply 14 generates an AC current in the conductors 4 and 6. By means of the inductive coupling with conductor 6, energy can be transported to the sensing node 18.1 in a similar way as discussed in relation to FIGS. 6 and 7. By submitting by means of the data processing and generating device 16, a data signal onto the conductors 10 and 12 the corresponding changing current in the second coil 54′ will generate a corresponding signal in the first coil 46′ which is connected with the control unit 30. Also if the control unit 8 generates a data signal in the second coil 46′ a corresponding signal will be generated in the second coil 54′ and which via the conductors 12, 6 can be received by the data processing and generating unit 16.

In FIG. 9 an alternative embodiment of a system according to the invention is shown. In FIG. 9 the conductors 4, 6 are shown by a single line wherein these conductors are connected with the power supply 14. The data processing and generating unit 16 is connected to a first data line which is formed by conductors 10, 12 which conductors are again shown by a single line in FIG. 9. Furthermore, conductors 10′, 12′ are also shown as a single data line. Thus, the embodiment of fig., 9 comprises a power line 4, 6 and two data lines 10, 12; 10′, 12′. In this example the sensing node 18.1 is attached to the power line 4,6 and the data line 10′,12′ in a similar way as for example discussed in relation to FIG. 1. The same applies to the sensing nodes 18.2, 18.3 and 18.4. However, the sensing node 18.5, 18.6, 18,7 and 18.8 are each attached to the power lines 4, 6 and the data lines 10, 12 in a similar way as discussed for FIG. 1. Thus, each of the sensing node 18.i is provided with power via de power line 4, 6. The data exchange between the sensing nodes 18.1-18.4 on the one hand and the data processing and generating unit 16 on the other hand takes place via data line 10′, 12′. The data exchange between sensing nodes 18.5-18.8 and the data processing and generating unit 16 takes place via the data line 10, 12.

It holds for each of the embodiments discussed, that the sensing node may be provided with a memory device wherein an identification code of the node is stored. The memory device 80 can for example, be a part of the control unit 30 as is indicated in FIGS. 2e and 3c. The sensing node is so arranged that it submits information about the identification code which is stored in the memory 80 in electric form to for example the first coil 46′ of FIG. 2a, for example in combination with information which is obtained by means of the sensor 28. In this way the data processing and generating unit 16 may receive the information which is generated by the sensor 28 in association with the identification code. In this way the data processing and generating device knows from which sensor node the information originates. Similarly, if the data processing and generating unit 16 submits a signal to the conductors 10 and 12 of the embodiment of FIG. 2e in order to submit information to the node 18.1 it can submit such information in association with the identification code which is stored in memory 80 of the sensing node 18.1. In this way the control unit 30 will recognize this information to be intended to be received by the sensing node 18.1. This information can, for example, comprise a command which has to be executed by the control unit 30. In a complete similar way the data processing and generating unit 16 of the embodiment of FIG. 4c can exclusively communicate with the control unit 30 of the sensing node 18.1 if in the memory 80 of the control unit 30 the identification code is stored which is also submitted by the data processing and generating unit in association with for example a command for the sensing node 18.1. Also if the control unit 30 submits information obtained from the sensor 28 to the conductors 4, 6 it will in association with this information submit information about the identification codes which are stored in the memory 80 so that upon receipt of the information the data processing and generating device knows from which sensing node the received information originates.

Furthermore it holds that each of the systems described may be arranged for determining the position of the node relatively to the trigger, control unit or a predefined reference point. Possible embodiments will be discussed based on the embodiment of FIG. 2e. In this embodiment the data processing and/or generating device 16 forms also a so called trigger unit or a so called pinging unit. If the data processing and/or pinging unit functions as a pinging unit than the pinging unit is arranged to submit a pinging signal to the conductors 10,12. The pinging signal is for example associated with an identification code which is also submitted to the conductors 10, 12. In this example it is assumed that the pinging signal comprises the identification code which belongs to the sensing node 18.1. The control unit 30 of the sensing node 18.1 is so arranged that upon receipt of the pinging signal which comprises its identification code, it will respond by a reply which is also submitted to the conductors 12, 10. The pinging unit will detect the reply. The reply can for example be a pulse or a predetermined data signal which can be recognized by the pinging unit. If the pinging unit receives the reply it will calculate, based on the time difference between submitting the pinging signal and receiving the reply, the length of the conductor which of the conductors which extends between the device 16 and the sensor node 18.1. For this, the pinging unit can be programmed with the predetermined velocity of a signal which propagates through the conductors and the response time of the sensing node (that is the time which lapses between the receipt of the pinging signal and submitting the reply). If the data processing and/or generating unit functions as a trigger unit than the pinging unit is arranged to submit a trigger signal to the conductors 10, 12. The trigger signal is for example associated with an identification code which is also submitted to the conductors 10, 12. In this example it is assumed that the trigger signal comprises the identification code which belongs to the sensing node 18.1 and information such as a command for the sensing node 18.1. The control unit 30 of the sensing node 18.1 is so arranged that upon receipt of the trigger signal which comprises its identification code, it will respond in accordance with the command signal. The command signal may cause the sensing node 18.1 to start an action like recording of data or carrying out a health check and report to the data processing and/or generating unit accordingly.

It is noted that the scope of the present invention also incorporates other embodiments discussed. In each of the discussed embodiments the attachment device 22 and the inductive coupling device 24 are formed by one and the same device. It is noted that for example in FIG. 2a the coil 54 may be clamped in the ferrite body 34 for proper fixation of the sensing node relative to the conductors. It is however also possible that such clamping is not arranged for. It is for example also possible that the unit 18.1 is provided with a separate attaching device 23, for example in the form of a clamp for attaching the node 18.1 to any of the conductors, for example to conductor 4 and/or conductor 6 and/or conductor 10 and/or conductor 12. In that case the function of the ferrite body 34 is merely providing an inductive coupling device. It also means that the attachment device may attach the sensing nodes to anyone of the conductors 4, 6, 10 and/or 12. Furthermore, as explained the inductive coupling device can provide an inductive coupling with conductor 4 or, conductor 6, or with conductor 4 and conductor 6. The same applies mutatis mutandis for inductive coupling device 24′ with respect to the conductors 10 and 12.

It is further noted that each of the described embodiments the third leg 36.3 may be omitted. For example in FIG. 2a it will be clear that if the third leg 36.3 is omitted the ferrite body effectively comprises a ring-shaped body which is indicated with dashed lines wherein the first coil and the second coil each surround a portion of the ring-shaped body. Also in this case, for example, the first coil may surround the first leg an/or the second leg whereas the second coil may also surround the first leg and/or the second leg. In the embodiment of FIG. 2a it is even possible to omit the first leg and the third leg so that only a second leg remains wherein, in that case, the first coil and the second coil each surround the second leg. Similar modifications are possible for the other ferrite bodies described in the examples of the present application.

Finally, in FIG. 10 a specific embodiment of a ferrite body is shown which can be used in each of the previous embodiments discussed. FIG. 10 shows a pin part 82 which comprises the second leg 36.2. Furthermore, a body part 84 comprises the first leg and the third leg 36.1 and 36.3. Furthermore a clamping part 86 is provided. For example the conductors 4, 6 will be located within the part 84 as indicated in the drawing. The conductors can be clamped between the parts 84 and 86 and will be separated from each other by means of the second leg 36.2. The clamping part 86 can be fixed to the body part 84 by means of a clip 88. The knob 86 of the pin 82 can for example be attached to a PCB. Such embodiments each fall within the scope of the present invention.

In the discussed embodiments the free ends of conductors 10, 12 can be closed by an impedance as shown in some of the drawings to avoid reflections. This is however not essential and the free end may also remain unclosed in for example he embodiment of FIG. 1. Also in the embodiments discussed the free end of the conductors 4, 6 may be short circuited as shown in some of the drawings. The power supply may work in a current mode. This is however not essential and the free ends of the conductors 10, 12 may also remain unclosed in for example the embodiment of FIG. 1. The power supply may work in a voltage mode. Also such varieties fall within the scope of the invention. In FIGS. 1, 5, 6 and 8 the free ends of the conductors 4,6 may, but need not terminated by means of an impedance Z1. The impedance Z1 may for example provide a short circuit. In FIGS. 1, 5 and 6 the free ends of the conductors 10, 12 may, but need not, be connected via an impedance Z2. The impedance Z2 may for example avoid reflections of data transferred through these conductors (Z2 is a so-called characteristic impedance of the conductors 10, 12). In FIG. 8 the free ends of the conductors 6, 12 may, but need not, also be connected via an impedance Z2. In FIGS. 4a and 7 the free ends of the conductors 4, 6 may, but need not be connected via an impedance Z.

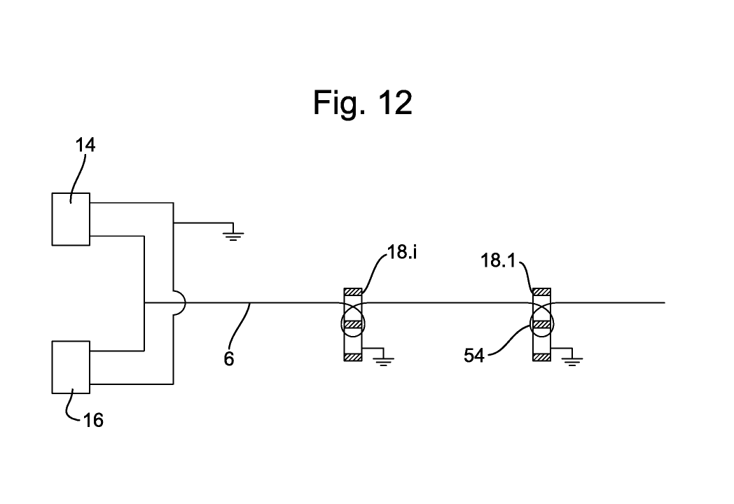

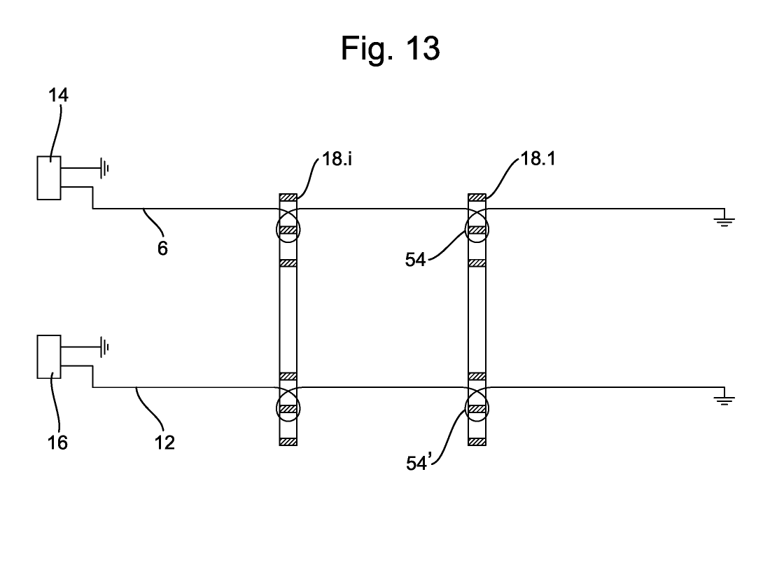

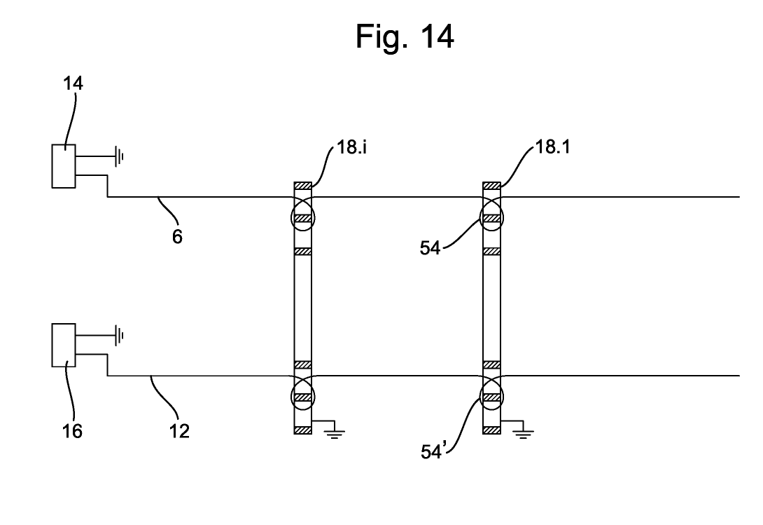

In FIG. 7 the conductor 4 provides a means for closing a required current loop for submitting data and/or power. It is noted that conductor 4 may be deleted if the closing of the current loop can for example be established by grounding the free end of the conductor 6 (FIG. 11) and/or the nodes (FIG. 12) on the one hand and grounding the power supply and/or the data generating and processing means on the other hand (FIG. 11, 12). The grounding medium may for example be sea water. In a similar manner conductor 4 and/or conductor 10 may be deleted in FIG. 6 and be respectively replaced by grounding the free ends of the conductors 6 and/or 10 (FIG. 13) and/or by grounding the nodes (FIG. 14) on the one hand and by grounding the power supply 14 and/or the unit 16 on the other hand (FIG. 13, 14).

Further embodiments are also possible. For example the system may be arranged such that the power transfer frequencies of the electric energy submitted by the at least one power supply differs from the data transfer frequencies used for submitting and receiving of data by the at least one node and the at least one data processing and receiving means. Such an embodiment can be formed by the embodiment as shown in FIG. 4a.

For each of the embodiments it holds that the node may be provided with a switching device for selectively bypassing windings of the at least one first coil such that the coupling performance can be adjusted as designed after protection. Such switching device 100 may be controlled by the control unit 30, an example of which is shown in FIG. 4c. In FIG. 4c the coil 46 comprises schematically three windings 46.1, 46.2 and 46.3 wherein winding 46.2, 46.3 may be short circuited by means of the switching device 100 which comprises controllable switches 102 and 104.

In a further embodiment the system may also be arranged to short circuit the at least one first coil. In this way the power consumption of the system can be minimized when it is not in operation. Such an embodiment is shown in FIG. 2e wherein by means of controllable switches 104 and 106 the coils 46 and 46′ may respectively be short circuited. The switches 104 and 106 may be controlled by the control unit 30. A command can be provided to the control unit by means of the unit 16 that for example the switches should remain closed for a predetermined period of time.

In the aforementioned example it was indicated that a Manchester coding may be used. However, it may also be that the system is arranged to use a communication protocol that is based on Frequency Division Multiple Access (FDMA) for submitting data to the at least one sensor device via the electrical connection means and/or for receiving data from the at least one sensor device via the electrical connection means. Alternatively it may be that the system is arranged to use a communication protocol that is based on Time Division Multiple Access (TDMA) for submitting data to the at least one sensor device via the electrical connection means and/or for receiving data from the at least one sensor device via the electrical connection means.

For each of the embodiments discussed it may hold that the at least one node is arranged such that it can be activated or triggered via the at least one conductive core by pulse counting. Furthermore it may hold for each of the discussed embodiments that the at least one node is designed to perform a self-condition check, preferably on demand by the data processing and/or generating device wherein the at least one node is further designed to report back to the data processing and/or generating device the result of such check, for example any malfunction or error situation. It also holds for each of the discussed embodiments that the at least one sensor device comprises at least one sensor from the group which comprises but is not limited to a an acoustic sensor, a sensor for detecting a magnetic field sensor, a sensor for detecting an electric field, an acceleration sensor, an inclination sensor, a gyroscopic sensor, a sensor for detecting energetic particles (Geiger), a sensor for detecting light/photons (IR, UV, visible spectra), a sensor for detecting heat, a sensor for detecting moisture, a sensor for detecting humidity, a combustion sensor, a sensor for detecting biological agents, a sensor for detecting a chemical reaction, a sensor for detecting mechanical forces, a sensor for detecting fluid flow (MFC/vane types etc), a sensor for detecting gas flow (MFC/vane types etc), a vibration sensor, a hydrostatic pressure sensor, a gas pressure sensor, a temperature sensor, a movement sensor, a 3 dimensional accelerometer, a velocity sensor, a (bio)chemical sensor, a compass, a gravity sensor, an antenna, an audio sensor, a camera.

Preferably it holds for each of the embodiments that the at least one node is sealed, preferably hermetically sealed. Furthermore for each of the embodiments power may be provided from the power supply 14, to the data processing and generating unit 16, from the data processing and generating unit 16 to (any one of) the conductors 4, 6, 10, 12 and via (any one) of the conductors to the nodes 18.i.

Each of the embodiments described above may be used as a streamer for seismic research. Examples will be provided in FIGS. 15a, 15b, 16.

As schematically shown in FIG. 15a the system is transported, preferably by means of a ship 200 in a streaming direction 202. The system is provided with a plurality of groups 204.i (i=1,2,3, . . . ), wherein each group comprises a data processing and/or generating unit 16, at least one downward first conductor 4,6,10,12 extending against the streaming direction stream downwards of the data processing and/or generating unit and at least one downward second conductor 4,6,10,12 extending against the streaming direction stream downwards of the data processing and/or generating unit 16.

Each group further comprises at least one sensing node 18.i which comprises at least one sensor device wherein each conductor is provided with at least one electrically conductive core surrounded by an insulating sheath wherein the at least one sensor device is electrically connected with at least one conductive core of the at least one first conductor and wherein the at least one node is provided with an attachment device for mechanically attaching the at least one node to the at least one second conductor. The attachment device is arranged for mechanically attaching the at least one node 18.i to the at least one first conductor such that the insulating sheath at the location where the at least one node is attached to the at least one first conductor remains intact; and wherein the node is further provided with an inductive coupling device which is arranged to provide the electrical connection in the form of an inductive coupling of the at least one sensor device with at least one conductive core of the at least one second conductor if the node is mechanically attached to the at least one first conductor by means of the attachment device and wherein the sheath of the at least one second conductor from which the core is inductively coupled to the at least one sensor device by means of the coupling device remains intact on the position where the inductive coupling device provides the inductive coupling with the core

The at least one downward first conductor and the at least one downward second conductor may be the same conductor, may be the same conductors or may be different conductors. Thus each group may take one of the embodiments as discussed above. Thus each group may also comprise an impedance Z.

The groups 204.i are distributed relative to each other in the streaming direction 202 such that the system has a length L in the streaming direction which is longer than the individual length 1 of each group in the streaming direction preferably a length L in the streaming direction which is at least substantially the same as the sum of individual lengths 1 in the streaming direction of the groups. The groups are mechanically connected to each other by means of connection devices 206. The system is further provided with a power and/or data bus 210 extending in the streamer direction and being electrically connected to each of the data processing and/or generating units 16 of the groups. Power may be provided from the ship 200 (the power supply may be on the ship and connected with the bus 210) to the nodes 18.i via the bus 210, the data processing and/or generating unit 16 and the conductors 4, 6,10,12. Information between the ship and the nodes 18.i may be exchanged via the bus 210, the data processing and/or generating unit 16 and the conductors 4, 6,10,12.The system is towed by means of a cable 212. Than in fact the groups form a chain of groups.

An alternative streamer system is shown in FIG. 15b. The system is provided with a plurality of groups 204.i (I=1,2,3, . . . ), wherein each group comprises a data processing and/or generating unit 16, at least one upward first conductor 4,6,10,12 extending in the streaming direction stream upwards of the data processing and/or generating unit and at least one upward second conductor 4,6,10,12 extending in the streaming direction stream upwards of the data processing and/or generating unit 16.

Each group further comprises at least one sensing node 18.i which comprises at least one sensor device wherein each conductor is provided with at least one electrically conductive core surrounded by an insulating sheath wherein the at least one sensor device is electrically connected with at least one conductive core of the at least one first conductor and wherein the at least one node is provided with an attachment device for mechanically attaching the at least one node to the at least one second conductor. The attachment device is arranged for mechanically attaching the at least one node to the at least one first conductor such that the insulating sheath at the location where the at least one node is attached to the at least one first conductor remains intact; and wherein the node is further provided with an inductive coupling device which is arranged to provide the electrical connection in the form of an inductive coupling of the at least one sensor device with at least one conductive core of the at least one second conductor if the node is mechanically attached to the at least one first conductor by means of the attachment device and wherein the sheath of the at least one second conductor from which the core is inductively coupled to the at least one sensor device by means of the coupling device remains intact on the position where the inductive coupling device provides the inductive coupling with the core

The at least one upward first conductor and the at least one upward second conductor may be the same conductor, may be the same conductors or may be different conductors. Thus each group may take one of the embodiments as discussed above. Thus each group may also comprise an impedance Z, Z1, Z2.

The groups 204.i are distributed relative to each other in the streaming direction 202 such that the system has a length L in the streaming direction which is longer than the individual length 1 of each group in the streaming direction preferably a length L in the streaming direction which is at least substantially the same as the sum of individual lengths 1 in the streaming direction of the groups. The groups are mechanically connected to each other by means of connection devices 206. The system is further provided with a power and/or data bus 210 extending in the streamer direction and being electrically connected to each of the data processing and/or generating units of the groups. Power may be provided from the ship 200 to the nodes 18.i via the bus 210, the data processing and/or generating unit 16 and the conductors 4, 6, 10, 12. Information between the ship and the nodes 18.i may be exchanged via the bus 210, the data processing and/or generating unit 16 and the conductors 4, 6, 10, 12.The system is towed by means of a cable 212. Than in fact the groups form a chain of groups.

An alternative streamer system is shown in FIG. 16. The system is transported, preferably by means of a ship 200, in a streaming direction 202 wherein the system is provided with a plurality of groups 204.i, wherein each group comprises a data processing and/or generating unit 16, at least one upward first conductor 4,6,10,12 extending in the streaming direction stream upwards of the data processing and/or generating unit, at least one downward first conductor 4′,6′,10′,12′ extending against the streaming direction stream downwards of the data processing and/or generating unit, at least one upward second conductor 4,6,10,12 extending in the streaming direction stream upwards of the data processing and/or generating unit and at least one downward second conductor 4′,6′,10′,12′ extending against the streaming direction stream downwards of the data processing and/or generating unit.

Each group 204.i further comprises at least one upward sensing node 18.i which comprises at least one sensor device wherein each conductor is provided with at least one electrically conductive core surrounded by an insulating sheath wherein the at least one sensor device is electrically connected with at least one conductive core of the at least one upward second conductor and wherein the at least one node is provided with an attachment device for mechanically attaching the at least one node to the at least one upward first conductor. The attachment device is arranged for mechanically attaching the at least one node 18.i to the at least one upward first conductor 4, 6, 10, 12 such that the insulating sheath at the location where the at least one node is attached to the at least one first conductor remains intact; and wherein the node is further provided with an inductive coupling device which is arranged to provide the electrical connection in the form of an inductive coupling of the at least one sensor device with at least one conductive core of the at least one upward second conductor 4, 6, 10, 12 if the node is mechanically attached to the at least one upward first conductor by means of the attachment device and wherein the sheath of the at least one upward second conductor from which the core is inductively coupled to the at least one sensor device by means of the coupling device remains intact on the position where the inductive coupling device provides the inductive coupling with the core.

In addition each group further comprises at least one downward sensing node 18.i’ which comprises at least one sensor device wherein each conductor is provided with at least one electrically conductive core surrounded by an insulating sheath wherein the at least one sensor device is electrically connected with at least one conductive core of the at least one downward second conductor 4′, 6′, 10′, 12′ and wherein the at least one node is provided with an attachment device for mechanically attaching the at least one node to the at least one downward first conductor. The attachment device is arranged for mechanically attaching the at least one node 18.i′ to the at least one downward first conductor 4′, 6′, 10′, 12′ such that the insulating sheath at the location where the at least one node is attached to the at least one downward first conductor remains intact; and wherein the node 18.i′ is further provided with an inductive coupling device which is arranged to provide the electrical connection in the form of an inductive coupling of the at least one sensor device 18.i′ with at least one conductive core of the at least one downward second conductor 4′, 6′, 10′, 12′ if the node is mechanically attached to the at least one downward first conductor by means of the attachment device and wherein the sheath of the at least one downward second conductor from which the core is inductively coupled to the at least one sensor device of the at least one node 18.1′ by means of the coupling device remains intact on the position where the inductive coupling device provides the inductive coupling with the core.

The at least one upward first conductor 4, 6, 10, 12 and the at least one upward second conductor 4, 6, 10, 12 may be the same conductor, may be the same conductors or may be different conductors. Also the at least one downward first conductor 4′, 6′, 10′, 12′ and the at least one downward second conductor 4′, 6′, 10′, 12′ may be the same conductor, may be the same conductors or may be different conductors. Thus for each group it holds that the combination of a data processing and/or generating unit and at least one first upward conductor and at least one second upward conductor and the at least one upward node may be formed by each of the embodiments discussed above. Thus an upward impedance Z, Z1, Z2; may also be provided (in the figures only Z is provided). Furthermore it holds for each group that the combination of the data processing and/or generating unit and at least one first downward conductor and at least one second downward conductor and the at least one downward node may be formed by each of the embodiments discussed above. Thus an downward impedance Z′, Z1′, Z2′; may also be provided (in the figures only Z′ is provided). The length 1 in FIG. 16 may be the same as the length 1 in FIGS. 15a and 15b. The advantage of the system according to FIG. 16 relative to the system according to FIGS. 15a and 15b is that the length of the conductors 4, 6, 10, 12, 4′, 6′, 10′, 12′ in FIG. 16 is half the length of the conductors 4, 6, 10, 12 in FIG. 15a and FIG. 15b. This means a possible higher data rate through the conductors 4, 6, 10, 12,4′,6′, 10′, 12′ of FIG. 16 and less power losses in the conductors 4, 6, 10, 12,4′,6′,10′,12′ of FIG. 16.

The groups are distributed relative to each other in the streaming direction 202 such that the system has a length in the streaming direction which is longer than the individual length of each group in the streaming direction preferably a length in the streaming direction which is at least substantially the same as the sum of individual lengths in the streaming direction of the groups. The groups are mechanically connected to each other by means of connection devices 206. The system is further provided with a power and/or data bus 210 extending in the streamer direction and being electrically connected to each of the data processing and/or generating units of the groups. Power may be provided from the ship 200 to the nodes 18.i, 18i′ via the bus 210, the data processing and//or generating unit 16 and the conductors 4, 6, 10, 12, 4′, 6′, 10′,12′. Information between the ship and the nodes 18.i, 18i′ may be exchanged via the bus 210, the data processing and/or generating unit 16 and the conductors 4, 6, 10, 12, 4′, 6′, 10′, 12′. The system is towed by means of a cable 212. Than in fact the groups form a chain of groups.

1.-41. (canceled)

42. A system comprising:
at least two conductors, wherein each conductor includes a conductive core surrounded by an insulating sheath; and
at least one sensing node, the at least one sensing node including at least one sensor device and an inductive coupling device, the inductive coupling device including a permeable magnetic body, a first coil surrounding the permeable magnetic body and being electrically connected to the at least one sensor device, a second coil surrounding the permeable magnetic body so that the first coil and the second coil are inductively coupled by the body, the body including three legs where the first coil surrounds a first leg and the second coil surrounds a second leg, a first body portion which extends between first ends of each of the legs, a second body portion which extends between second ends of each of the legs and two body parts which are arranged to be at least partly separated from each other and reattached to each other for positioning the first coil to surround at least one of the three legs or for releasing the first coil from the at least one leg of three legs,
wherein the at least one sensing node includes an attachment device for mechanically attaching the at least one sensing node to a first conductor of the at least two conductors at a first location such that the insulating sheath of the first conductor at the first location remains intact,
wherein the at least one sensor device is electrically connected with a conductive core of a second conductor of the at least two conductors,
wherein the inductive coupling device electrically connects, via an inductive coupling, the at least one sensor device with the conductive core of the second conductor at a second location such that the insulating sheath of the second conductor remains intact at the second location, when the at least one sensing node is mechanically attached to the first conductor by the attachment device.

43. The system according to claim 42, wherein the attachment device and the inductive coupling device are arranged so that when the at least one sensing node is detached from the first conductor the first location and second location remain intact.

44. The system according to claim 42, further comprising:
at least one power supply electrically connected with the conductive core of the second conductor for providing electric power to the at least one sensor device via the inductive coupling device.

45. The system according to at least claim 44, further comprising:
a first pair of conductors and at least one additional conductor, wherein the first pair is coupled to the power supply and the at least one additional conductor is coupled to a data processing device,
wherein the at least one sensing node includes a first coupling device for coupling the at least one sensor device with the first pair of conductors for providing power to the at least one sensor device and wherein the at least one sensing node includes a second coupling device for providing a data connection between the data processing device and the at least one sensor device via the at least one additional conductor.

46. The system according to claim 45, wherein the first pair and the at least one additional conductor have no conductors in common or the first pair and the at least one additional conductor have one conductor in common.

47. The system according to claim 42, further comprising:
at least one data processing device electrically connected with the conductive core of the second conductor for submitting data to the at least one sensor device via the electrical connection and for receiving data from the at least one sensor device via the electrical connection.

48. The system according to claim 42, wherein the attachment device is arranged for mechanically attaching the at least one sensing node to each of the at least two conductors such that the insulating sheath at locations where the at least one sensing node is attached to the at least two conductors remains intact and when the at least one sensing node is detached from the at least two conductors at the locations, the insulating sheath remains intact.

49. The system according to claim 42, wherein the inductive coupling device electrically connects, via the inductive coupling, the at least one sensor device with each conductive core of the at least two conductors when the node is mechanically attached to a conductor of the at least two conductors by the attachment device, and the inductive coupling device remains intact when the at least one sensing node is detached from a conductor of the at least two conductors.

50. The system according to claim 42, wherein where the attachment device forms the inductive coupling device.

51. The system according to claim 42, wherein the inductive coupling device includes a removable clip for attaching the first body part and the second part.

52. The system according to claim 42, wherein the body is toroidal shaped and the first coil and the second coil each surround a portion of the toroidal shaped body, the torodial shaped body including two body parts arranged to be at least partly separated from each other and reattached to each other for positioning the first coil to surround the portion of the toroidal shaped body and for releasing the first coil from the toroidal body.

53. The system according to claim 42, wherein the at least one sensor device is selected from a group comprising an acoustic sensor, a sensor for detecting a magnetic field sensor, a sensor for detecting an electric field, an acceleration sensor, an inclination sensor, a gyroscopic sensor, a sensor for detecting energetic particles (Geiger), a sensor for detecting light/photons (IR, UV, visible spectra), a sensor for detecting heat, a sensor for detecting moisture, a sensor for detecting humidity, a combustion sensor, a sensor for detecting biological agents, a sensor for detecting a chemical reaction, a sensor for detecting mechanical forces, a sensor for detecting fluid flow (WC/vane types etc.), a sensor for detecting gas flow (WC/vane types etc.), a vibration sensor, a hydrostatic pressure sensor, a gas pressure sensor, a temperature sensor, a movement sensor, a 3 dimensional accelerometer, a velocity sensor, a (bio)chemical sensor, a compass, a gravity sensor, an antenna, an audio sensor, a camera.

54. The system according to claim 42, further comprising a plurality of nodes attached randomly or at predefined locations to the first conductor.

55. The system according to claim 42, wherein the system is a streamer for seismic research.

56. A system comprising:
a plurality of groups, wherein each group of the plurality of groups comprises:
an upward sensing node including an upward attachment device for mechanically attaching the upward sensing node to an upward first conductor at a upward first location such that an insulating sheath of the upward first conductor remains intact;
an upward sensor device electrically connected with a conductive core of an upward second conductor, wherein the electrical connection is an inductive coupling when the upward sensing node is mechanically attached to the upward first conductor by the upward attachment device and the inductive sheath of the upward second conductor remains intact at an upward second location of the inductive coupling between the upward sensor device and the conductive core of the upward second conductor;
a downward sensing node including a downward attachment device for mechanically attaching the downward sensing node to a downward first conductor at a downward first location such that an insulating sheath of the downward first conductor remains intact; and
a downward sensor device electrically connected with a conductive core of a downward second conductor, wherein the electrical connection is an inductive coupling when the downward sensing node is mechanically attached to the downward first conductor by the downward attachment device and an inductive sheath of the downward second conductor remains intact at a downward second location of the inductive coupling between the downward sensor device and the conductive core of the downward second conductor.

57. The system according to claim 56, further comprising:
a plurality of groups, wherein each group comprises a data processing unit, at least one upward first conductor extending in a streaming direction upwards of the data processing unit, at least one downward first conductor extending against a streaming direction downwards of the data processing unit, at least one upward second conductor extending in the streaming direction upwards of the data processing unit and at least one downward second conductor extending against the streaming direction downwards of the data processing unit,
wherein the plurality of groups are distributed relative to each other in the streaming direction such that a length of the system in the streaming direction is longer than an individual length of each group in the streaming direction and the length of the system in the streaming direction is at least substantially similar to the sum of each individual lengths of the groups in the streaming direction.

58. The system according to claim 57, further comprising:
a power and/or data bus extending in the streaming direction and being electrically connected to each of the data processing units of the plurality of groups.

59. The system according to claim 56, wherein the plurality of groups are mechanically connected to each other to form a chain of groups.

60. The system of claim 56, wherein the system is coupled to a ship and configured to provide seismic research.
